(19) United States
(12) Patent Application Publication
(10) Pub. No.: US 2022/0145853 A1
(43) Pub. Date: May 12, 2022

(54) AUTOMATIC RECOGNITION, MANAGEMENT AND CONTROL SYSTEM FOR DANGEROUS SOURCES IN WIND TURBINES

(71) Applicant: Huaneng Tongliao Wind Power Co., Ltd., Tongliao, (CN)

(72) Inventors: Guoqing Li, Tongliao (CN); Ting Liu, Tongliao (CN); Renjie Bai, Tongliao (CN); Shiying Li, Tongliao (CN); Jiarui Xue, Tongliao (CN); Yunpeng Li, Tongliao (CN); Yan Liu, Tongliao (CN); Da An, Tongliao (CN)

(21) Appl. No.: 17/402,642

(22) Filed: Aug. 16, 2021

(30) Foreign Application Priority Data
Nov. 9, 2020 (CN) 202011235836.1

(51) Int. Cl. F03D 7/00; G08B 21/18; G05B 13/02; F03D 17/00

(52) U.S. Cl. CPC F03D 7/00; F03D 17/00; G05B 13/0265; G08B 21/18

(57) ABSTRACT

An automatic recognition, management and control system for dangerous sources in wind turbines, including an intelligent service unit, a telecontrol platform, a graphic workstation, an intelligent analysis unit, a network unit, an intelligent binocular perception terminal, an intelligent perception terminal and an intelligent recognition terminal, where the telecontrol platform and the graphic workstation are both connected to the intelligent service unit, a signal output end of the intelligent analysis unit is connected to a signal input end of the intelligent service unit through a dedicated line, and signal output ends of the intelligent binocular perception terminal, the intelligent perception terminal and the intelligent recognition terminal are all connected to a signal input end of the intelligent analysis unit through the network unit.

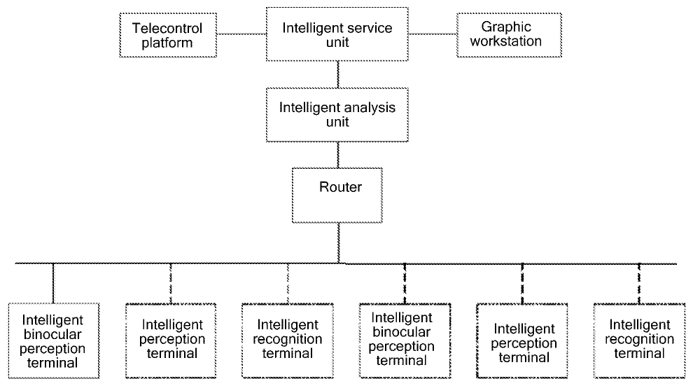

### CROSS REFERENCE TO RELATED APPLICATIONS

The present application claims the benefit of Chinese Patent Application No. 202011235836.1 filed on Nov. 9, 2020, the contents of which are incorporated herein by reference in their entirety.

### TECHNICAL FIELD

The present disclosure relates to the technical field of dangerous source monitoring of wind turbines, and specifically, to an automatic recognition, management and control system for dangerous sources in wind turbines.

### BACKGROUND

As the most important part of the wind power generation system, wind turbines play a vital role in the operation of wind farms. There are many dangerous points in the operation and maintenance of wind turbines, and the following situations need to be paid attention to: Abnormal heating of the equipment during operation causes fires, consequently, leading to equipment damage; short-circuit of outgoing transmission lines caused by uncontrollable factors causes the wind turbine to quit running; illegal operations during the operation and maintenance of the wind turbines cause personal injuries and deaths; and unrelated personnel and large vehicles break into the wind farm and cause equipment failure and wind turbine offline. Currently, there are two main methods for monitoring the dangerous sources of the wind turbine: The first is to install various sensors in the wind turbine, and manually monitor data changes in the various sensors to confirm whether there is a danger; the second is to require the operation and maintenance personnel to strictly implement the rules and regulations and remind and supervise each other during the work process, to prevent accidents.

However, the existing methods for monitoring the dangerous sources of the wind turbines have the following problems:

1. Due to the large number of wind turbines under video monitoring, the video screen of each wind turbine occupies a small proportion of the display screen, and the operator cannot clearly monitor the video screen of each wind turbine in real time. In addition, there are many uncontrollable factors in human behaviors. Consequently, dangers and abnormalities may not be found in time. Meanwhile, conventional sensors have a small monitoring range, and there are blind spots in which the equipment conditions cannot be fully reflected. These problems may eventually lead to equipment damage, personal injury, and the like.

2. There are many uncontrollable factors for personnel, and they are prone to work in violation of regulations, which may cause dangerous situations such as falling from a high altitude, high temperature scalding, electric shocks, and the like. The potential safety hazards are great, and therefore, improvements are needed.

### SUMMARY

The purpose of the present disclosure is to provide an automatic recognition, management and control system for dangerous sources in wind turbines, to resolve the following problems in the existing methods for monitoring the dangerous sources of the wind turbines mentioned in the Background Art: The operator cannot clearly monitor the video screen of each wind turbine in real time. Conventional sensors have a small monitoring range, and there are blind spots in which the equipment conditions cannot be fully reflected. There are many uncontrollable factors for personnel, and they are prone to work in violation of regulations, which may cause dangerous situations such as falling from a high altitude, high temperature scalding, electric shocks, and the like. The potential safety hazards are great.

To achieve the above objectives, the present disclosure provides the following technical solutions: An automatic recognition, management and control system for dangerous sources in wind turbines, including an intelligent service unit, a telecontrol platform, a graphic workstation, an intelligent analysis unit, a network unit, an intelligent binocular perception terminal, an intelligent perception terminal and an intelligent recognition terminal, where the telecontrol platform and the graphic workstation are both connected to the intelligent service unit, a signal output end of the intelligent analysis unit is connected to a signal input end of the intelligent service unit through a dedicated line, and signal output ends of the intelligent binocular perception terminal, the intelligent perception terminal and the intelligent recognition terminal are all connected to a signal input end of the intelligent analysis unit through the network unit.

Preferably, the intelligent service unit is connected to the telecontrol platform and the graphic workstation for data exchange and information display.

Preferably, the intelligent binocular perception terminal is used to intelligently recognize dangerous sources such as personnel intrusion, personnel violations and equipment heating.

Preferably, the intelligent recognition terminal is configured to recognize oil seepage and oil leakage, to prevent oil from leakage and combustion, and recognize rule violations of operation and maintenance personnel.

Preferably, the intelligent analysis unit analyzes information transmitted by the intelligent binocular perception terminal, the intelligent perception terminal and the intelligent recognition terminal, and sends, to the intelligent service unit, alarm information and monitoring information that are generated based on the analyzed data.

Preferably, the network unit includes an optical fiber and a router, and is configured to transmit data acquired by the intelligent binocular perception terminal, the intelligent perception terminal and the intelligent recognition terminal.

Preferably, there are multiple intelligent binocular perception terminals, intelligent perception terminals and intelligent recognition terminals, and the multiple intelligent binocular perception terminals, intelligent perception terminals and intelligent recognition terminals are distributed in different positions in the wind turbines.

The present disclosure provides an automatic recognition, management and control system for dangerous sources in wind turbines, which has the following beneficial effects:

(1) According to the present disclosure, the intelligent service unit, the intelligent analysis unit, the intelligent binocular perception terminal, the intelligent perception terminal and the intelligent recognition terminal are provided, to monitor the wind turbines in an all-round way, comprehensively improve intelligent operation and maintenance of the wind turbines, and prevent accidents, thereby providing a strong guarantee for the safe and stable operation of the wind turbines.

(2) The present disclosure provides a reasonable structure to take a clear shoot in a dark environment, so as to realize a common video monitoring function and ceaselessly monitor the wind turbine related equipment and personnel. In this way, real-time recognition and monitoring of equipment abnormalities and timely warning are achieved, safety blind spots are reduced, the number of manual inspections is decreased, operation and maintenance efficiency is improved, operation and maintenance costs are reduced, and the safety risks of patrol personnel is reduced. The present disclosure is convenient for promotion and use.

### BRIEF DESCRIPTION OF THE DRAWINGS

The sole FIGURE is a schematic structural diagram of a system according to the present disclosure.

### DETAILED DESCRIPTION

To make the objective, technical solutions and advantages of the present disclosure clearer and more comprehensible, the present disclosure will be further described below in detail in conjunction with embodiments. It should be understood that the specific embodiments described herein are merely intended to explain but not to limit the present disclosure. All other examples obtained by a person of ordinary skill in the art based on the examples of the present disclosure without creative efforts shall fall within the protection scope of the present disclosure.

As shown in the sole FIGURE, the present disclosure provides a technical solution: An automatic recognition, management and control system for dangerous sources in wind turbines includes an intelligent service unit, a telecontrol platform, a graphic workstation, an intelligent analysis unit, a network unit, an intelligent binocular perception terminal, an intelligent perception terminal and an intelligent recognition terminal, where the telecontrol platform and the graphic workstation are both connected to the intelligent service unit, a signal output end of the intelligent analysis unit is connected to a signal input end of the intelligent service unit through a dedicated line, and signal output ends of the intelligent binocular perception terminal, the intelligent perception terminal and the intelligent recognition terminal are all connected to a signal input end of the intelligent analysis unit through the network unit.

The intelligent service unit is connected to the telecontrol platform and the graphic workstation for data exchange and information display, thereby comprehensively realizing equipment visual monitoring, temperature measurement, defect recognition, and full coverage of personnel behaviors.

The intelligent binocular perception terminal can intelligently recognize dangerous sources such as personnel intrusion, personnel violations and equipment heating, so as to perform intelligent early-warning and increase safety.

The intelligent recognition terminal can recognize oil seepage and oil leakage, to prevent oil from leakage and combustion, and recognize rule violations of operation and maintenance personnel.

The intelligent analysis unit analyzes information transmitted by the intelligent binocular perception terminal, the intelligent perception terminal and the intelligent recognition terminal, and sends, to the intelligent service unit, alarm information and monitoring information that are generated based on the analyzed data.

The network unit includes an optical fiber and a router, and is configured to transmit data acquired by the intelligent binocular perception terminal, the intelligent perception terminal and the intelligent recognition terminal.

There are multiple intelligent binocular perception terminals, intelligent perception terminals and intelligent recognition terminals, and the multiple intelligent binocular perception terminals, intelligent perception terminals and intelligent recognition terminals are distributed in different positions in the wind turbines.

It should be noted that during operation of the automatic recognition, management and control system for dangerous sources in wind turbines, intelligent perception and recognition devices with different functions are arranged at different positions in the wind turbines to monitor the equipment temperature, and smoke and open flames. The intelligent recognition terminal is arranged in a cabin of the wind turbine, to recognize oil seepage and oil leakage, so as to prevent oil from leakage and combustion, and recognize rule violations of the operation and maintenance personnel. The intelligent binocular perception terminal is arranged at the bottom of a tower base to intelligently recognize dangerous sources such as personnel intrusion, personnel violations and equipment heating. The intelligent binocular perception terminal, the intelligent perception terminal and the intelligent recognition terminal are all connected to the intelligent analysis unit through the optical fibers and the router, and the video information acquired by the intelligent binocular perception terminals, the intelligent perception terminals and the intelligent recognition terminal is transmitted to the intelligent analysis unit. The intelligent analysis unit is connected to the intelligent service unit through the dedicated line, and the intelligent analysis unit sends, to the intelligent service unit, alarm information and monitoring information that are generated based on the analyzed data. The intelligent service unit is connected to the telecontrol platform and the graphic workstation for data exchange and information display, to finally achieve full coverage of equipment visual monitoring, abnormal equipment heating monitoring, oil leakage monitoring, and personnel rule violation recognition. The intelligent binocular perception terminal can not only recognize related equipment defects, oil leakage, smoke and open flames, and personnel rule violations, but can also monitor the equipment temperature; early warning is made once the abnormal equipment temperature is detected, to inform the operation and maintenance personnel to take effective measures to reduce the probability of fire, thereby reducing the risk of accidents. (2) The present disclosure provides a reasonable structure to take a clear shoot in a dark environment, so as to realize a common video monitoring function and ceaselessly monitor the wind turbine related equipment and personnel. In this way, real-time recognition and monitoring of equipment abnormalities and timely warning are achieved, safety blind spots are reduced, the number of manual inspections is decreased, operation and maintenance efficiency is improved, operation and maintenance costs are reduced, and the safety risks of patrol personnel is reduced. The present disclosure can monitor the wind turbines in an all-round way, comprehensively improve intelligent operation and maintenance of the wind turbines, and prevent accidents, thereby providing a strong guarantee for the safe and stable operation of the wind turbines.

The intelligent binocular perception terminal, the intelligent perception terminal and the intelligent recognition terminal may be computing devices such as desktop computers, notebooks, palmtops, and cloud servers; and the terminals each may include, but not limited to, components such as a camera, a sensor, a processor, and a memory. The intelligent service unit, the telecontrol platform, the graphic workstation and the intelligent analysis unit may all be processors, intelligent terminals, tablets, PCs, and cloud servers.

It should be noted that relational terms herein such as first and second are only used to distinguish one entity or operation from another entity or operation without necessarily requiring or implying any actual such relationship or order between such entities or operations. In addition, terms “include”, “contain”, or any other variations thereof are intended to cover non-exclusive inclusions, such that a process, a method, an article, or a device including a series of elements not only includes those elements, but also includes other elements that are not explicitly listed, or also includes inherent elements of the process, the method, the article, or the device.

Although the examples of the present disclosure have been illustrated and described, it should be understood that those of ordinary skill in the art may make various changes, modifications, replacements and variations to the above examples without departing from the principle and spirit of the present disclosure, and the scope of the present disclosure is limited by the appended claims and their legal equivalents.

1. An automatic recognition, management and control system for dangerous sources in wind turbines, comprising an intelligent service unit, a telecontrol platform, a graphic workstation, an intelligent analysis unit, a network unit, an intelligent binocular perception terminal, an intelligent perception terminal and an intelligent recognition terminal, wherein the telecontrol platform and the graphic workstation are both connected to the intelligent service unit, a signal output end of the intelligent analysis unit is connected to a signal input end of the intelligent service unit through a dedicated line, and signal output ends of the intelligent binocular perception terminal, the intelligent perception terminal and the intelligent recognition terminal are all connected to a signal input end of the intelligent analysis unit through the network unit.

2. The automatic recognition, management and control system for dangerous sources in wind turbines according to claim 1, wherein the intelligent service unit is connected to the telecontrol platform and the graphic workstation for data exchange and information display.

3. The automatic recognition, management and control system for dangerous sources in wind turbines according to claim 1, wherein the intelligent binocular perception terminal is configured to intelligently recognize dangerous sources such as personnel intrusion, personnel violations and equipment heating.

4. The automatic recognition, management and control system for dangerous sources in wind turbines according to claim 1, wherein the intelligent recognition terminal is configured to recognize oil seepage and oil leakage, to prevent oil from leakage and combustion, and recognize rule violations of operation and maintenance personnel.

5. The automatic recognition, management and control system for dangerous sources in wind turbines according to claim 1, wherein the intelligent analysis unit analyzes information transmitted by the intelligent binocular perception terminal, the intelligent perception terminal and the intelligent recognition terminal, and sends, to the intelligent service unit, alarm information and monitoring information that are generated based on the analyzed data.

6. The automatic recognition, management and control system for dangerous sources in wind turbines according to claim 1, wherein the network unit comprises an optical fiber and a router, and is configured to transmit data acquired by the intelligent binocular perception terminal, the intelligent perception terminal and the intelligent recognition terminal.

7. The automatic recognition, management and control system for dangerous sources in wind turbines according to claim 1, wherein there are multiple intelligent binocular perception terminals, intelligent perception terminals and intelligent recognition terminals, and the multiple intelligent binocular perception terminals, intelligent perception terminals and intelligent recognition terminals are distributed at different positions in the wind turbines.
